(19) United States
(12) Patent Application Publication
(10) Pub. No.: US 2016/0140390 A1
(43) Pub. Date: May 19, 2016

(54) LIVENESS DETECTION USING PROGRESSIVE EYELID TRACKING

(71) Applicant: Intel Corporation, Santa Clara, CA (US)

(72) Inventors: Rahuldeva Ghosh, Portland, OR (US); Ansuya Negi, Beaverton, OR (US)

(21) Appl. No.: 14/749,193

(22) Filed: Jun. 24, 2015

Related U.S. Application Data
(60) Provisional application No. 62/079,011, filed on Nov. 13, 2014.

(51) Int. Cl. G06K 9/00; G06T 7/00; H04N 5/225; G06T 7/20; G06K 9/52; H04N 5/33

(52) U.S. Cl. CPC G06K 9/00617; G06K 9/00604; G06K 9/52; G06K 9/00268; H04N 5/33; H04N 5/2256; G06T 7/20; G06T 7/0051; G06K 2009/4666

(57) ABSTRACT

Techniques for liveness detection using progressive eyelid tracking are disclosed. A series of frames of a user are captured by a camera. The user's face, including a pair of eyes and eyelids, are detected within each of a plurality of captured frames. A respective pair of regions of interest is extracted from each captured frame within the plurality of respective captured frames, each respective region of interest including a respective eye of the respective pair of eyes detected and a respective eyelid corresponding to the respective eye. A respective score corresponding to a percentage of the respective eye unobstructed by the respective eyelid is calculated for each region of interest. A liveness indication is generated by a pattern recognizer analyzing the series of respective pairs of scores for an abnormal eyelid movement sequence.

### CLAIM OF PRIORITY

This patent application claims the benefit of priority under 35 U.S.C. §119(e) to U.S. Provisional Patent Application Ser. No. 62/079,011, filed on Nov. 13, 2014, entitled, “LIVENESS DETECTION IN FACIAL RECOGNITION WITH SPOOF-RESISTANT PROGRESSIVE EYELID TRACKING,” which is hereby incorporated by reference herein in its entirety.

### TECHNICAL FIELD

Embodiments described herein generally relate to biometric computer authentication and more specifically to liveness detection in facial recognition using spoof-resistant progressive eyelid tracking.

### BACKGROUND

Facial recognition for authentication purposes allows a user to use her face to authenticate to a computer system. Generally, the user's face is captured and analyzed to produce and store a feature set to identify uniquely the user during a set-up process. When the user wishes to use her face in a future authentication attempt, a camera will capture a representation of the user's face and analyze it to determine whether it sufficiently matches the stored feature set. When a sufficient match between a current image capture of the user's face and the stored feature set is made, the user is authenticated to the computer system.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments or examples discussed in the present document.

FIG. 1 is a block diagram of an example of a system for liveness detection using progressive eyelid tracking, according to an embodiment.

FIG. 2 is an example of a sequence of eyelid movements in a blink, according to an embodiment.

FIG. 3 is a sequence of frames tracking blink characteristics of an eye, according to an embodiment.

FIG. 4 is a chart illustrating an eyelid sequence in a typical human blink pattern, according to an embodiment.

FIG. 5 illustrates an example abnormal blink pattern observed during a liveness spoofing attack based on an image-manipulated animation, according to an embodiment.

FIG. 6 is a flow diagram illustrating a method for liveness detection using progressive eyelid tracking, according to an embodiment.

FIG. 7 is a block diagram illustrating an example of a machine, upon which one or more embodiments may be implemented.

### DETAILED DESCRIPTION

Liveness detection refers to a process of detecting artificial objects that are presented to a biometric device with the intent to subvert the recognition system. For example, a system employing facial recognition as a means of authentication may use liveness detection to determine whether the face of the user being authenticated is “alive” (e.g., physically present) rather than simply an image or video of the user's face. Deficiencies of current liveness detection techniques in facial recognition are preventing the adoption of facial recognition as a secure authentication mechanism. Current means of liveness detection, such as blink detection and head movement tracking, may not be sufficiently secure or may not provide for a positive user experience. Without a reliable, consistent, and user-friendly means of thwarting spoofing attempts, facial recognition will not be accepted as a mainstream replacement for password-based authentication. Embodiments disclosed herein strengthen facial recognition by resolving the spoofing vulnerability with user-friendly and robust detection of human eyelid movement. Disclosed embodiments are resistant to spoofing attacks (e.g., image-manipulated animations) by progressively tracking movements of the user's eyelids, while requiring minimal user interaction, thus resulting in a more user-friendly authentication process.

Existing solutions for liveness detection may use blink or head movement tracking as means to differentiate a real human from a spoofed human. Blink detection solutions deployed in some current face recognition products on the market use binary eye states—“opened eye” and “closed eye”—and detect a blink by computing the difference between those two states. These existing solutions have several drawbacks. First, because false blink detections tend to increase if a user is walking or otherwise moving (such as in or on a vehicle), these existing solutions usually require a user to be still during face capture to try to prevent false blink detections. Second, these existing solutions usually require very good lighting conditions. Third, these existing solutions usually need very good cameras with excellent signal-to-noise ratios (“SNRs”). Fourth, these existing solutions usually require the user's eyes to open wide; these existing solutions usually do not work as well with smaller eyes or with faces at a distance. Finally, these existing solutions tend to be spoofed easily with image-manipulated animations.

In contrast, embodiments described herein perform successfully with almost any digital camera, including the low quality, embedded cameras included in most low-cost laptops currently on the market. In an example, a digital camera's SNR is not important because a sequence of eye movements is tracked; any noise present in the sequence, even if significant, is likely present in each frame of the sequence, and the algorithms factor out this noise.

The movements of a user's eyelids are tracked as the eyelids move from a closed position to an open position and/or from an open position to a closed position. The opened-to-closed and/or the closed-to-open movements are compared to a model of natural human eyelid movements. The comparison of the movements results in a determination of whether both eyes have blinked. In an example, this determination occurs only when the movements of the user's eyelids sufficiently match a blink model, thus resisting against spoofing attacks. Some observational conditions, such as sudden head movements, moving or waving images, and/or lighting variations during liveness detection, may result in a false blink being detected. In an example, one or more algorithms are used to mitigate the effects of one or more of these observational conditions.

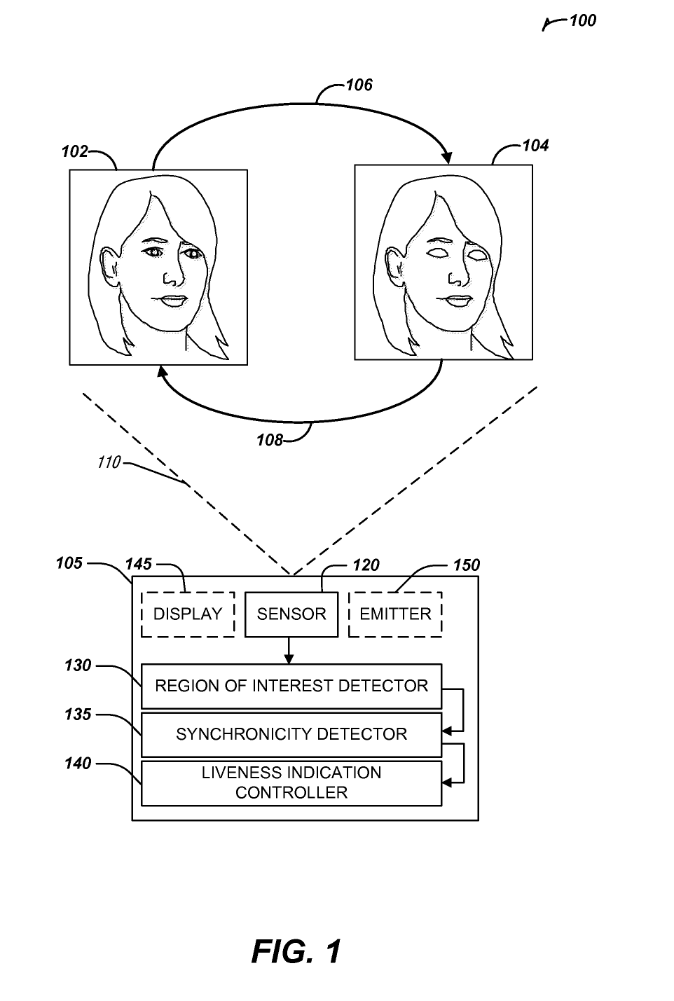

FIG. 1 is a block diagram of an example of a system 105 for image biometrics and an illustration of a blink-spoofing attack based on an image-manipulated animation 100, according to an embodiment. In a blink-spoofing attack based on an image-manipulated animation 100, a copy 104 of a first image 102 of a face is manipulated to cause the face in the copy 104 appear to have an opposite blink state from the face in the first image 102. For example, if the eyes were open in the first image 102 of the face, the copy 104 of the image of the face would be manipulated to cause the eyes to appear closed. The two images 102, 104 would then be combined into an animation 100, which cycles 106, 108 between the two images 102, 104.

An unsophisticated spoofing attack may involve modifying the animation to transition between the two images at the same rate. A more sophisticated spoofing attack may involve modifying the animation to transition between the two images at a rate typical for eyelid transitions. A typical interval between human blinks is two to ten seconds, and a typical period for a blink is 100 to 400 milliseconds (ms). Thus, in more sophisticated attacks, the transitions from an opened-eyes image to a closed-eyes image may be timed to occur every two to ten seconds, whereas the transitions from a closed-eyes image to an opened-eyes image may be timed to occur between 50 ms and 200 ms (e.g., approximately half of a normal blink period). Embodiments disclosed herein are able to resist against both of these liveness-spoofing attacks, among others.

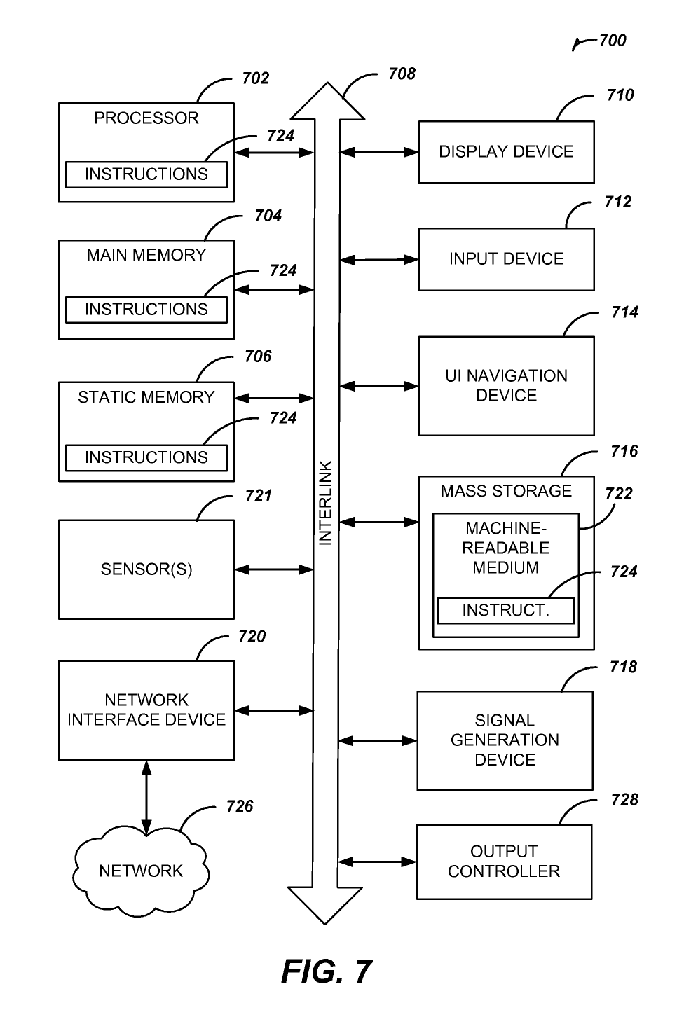

The system 105 may include a sensor 120 (e.g., a digital camera or video recorder, a non-visible light detector, etc.), optionally a display 145 (e.g., a screen, monitor, visible light emitter, etc.), optionally an additional emitter 150 (e.g., an infrared (IR) or other non-visible or visible light spectrum emitter), a region of interest detector 130, a synchronicity detector 135, and a liveness indication controller 140. The system 105 may also include an authentication controller (not shown) to actually perform an authentication of a user 115. Each of these components is implemented in computer hardware, such as a circuit set, as described below with respect to FIG. 7.

As used herein, the term “visible light” means light that is visible to a subject (e.g., a user). The term “red-green-blue” is used herein as a synonym for “visible light,” rather than referring to a particular color model. Thus, “red-green-blue” light may be represented in the RGB color model or the CMYK color model, among others.

The system 105 may obtain a sequence of images from the sensor 120. The sequence of images includes a first plurality of images (e.g., frames, pictures, etc.) including a representation of a user's face. As used herein, the representation of the body part is the sensor representation of the actual part. Thus, a digital image of the user's face is the representation of the face. As illustrated, the sensor 120 is a camera with a field of view 110 that encompasses the image-manipulated animation 100. In an example, the obtained sequence of images may be processed to reduce noise (e.g., application of a filter). In an example, the obtained sequence of images may be processed to reduce color information. In an example, the color information may be reduced to one bit per pixel (e.g., black and white).

In an example, the region of interest detector 130 obtains facial data corresponding to a face from sensor 120 and determines a region of interest of the face. In an example, the region of interest includes an eye and its associated eyelid. In an example, the region of interest detector 130 detects two regions of interest within an image of a user's face: one region of interest corresponding to the user's right eye and eyelid (“right region of interest”) and one region of interest corresponding to the user's left eye and eyelid (“left region of interest”).

The synchronicity detector (SD) 135 may quantify a correlation between the right and left regions of interest in the sequences of images to produce a synchronicity metric of the degree to which the right and left regions of interest correlate. Thus, the right and left regions of interest are compared to determine how close they are. A value is then assigned to this closeness. The value may be one of several discrete values, a real representation (e.g., a numerical representation to the precision allowed by the computing hardware), a binary representation, etc.

In an example, the correlation may be the degree to which the measured eye blinking sequence conforms to the eye blinking model. In this example, a strong correlation indicates a live person whereas a poor correlation indicates a spoofing attempt. In an example, the degree to which the measured eye blinking sequence conforms to the model may be determined by processing, through a pattern recognizer, the series of respective scores calculated from a percentage of the eye unobstructed by the eyelid. In this example, the pattern recognizer checks the series of respective scores for at least one of an abnormal eyelid sequence or an abnormal blink sequence based on the model. In an example, the pattern recognizer may serially check the abnormal blink sequence after verifying that the eyelid sequence is normal. That is, the eyelid sequence check is performed first. If it passes, then the abnormal blink sequence is checked.

The liveness indication controller (LIC) 140 may provide a spoofing attempt indication in response to the synchronicity metric being beyond a threshold. In an example, the LIC 140 may provide a liveness indication or otherwise classifies the human face as live in addition to, or instead of, providing the spoofing indication. In an example, the authentication attempt may be denied with the spoofing attempt indication. In an example, the spoofing indication is provided to another system component to be used in the authentication process.

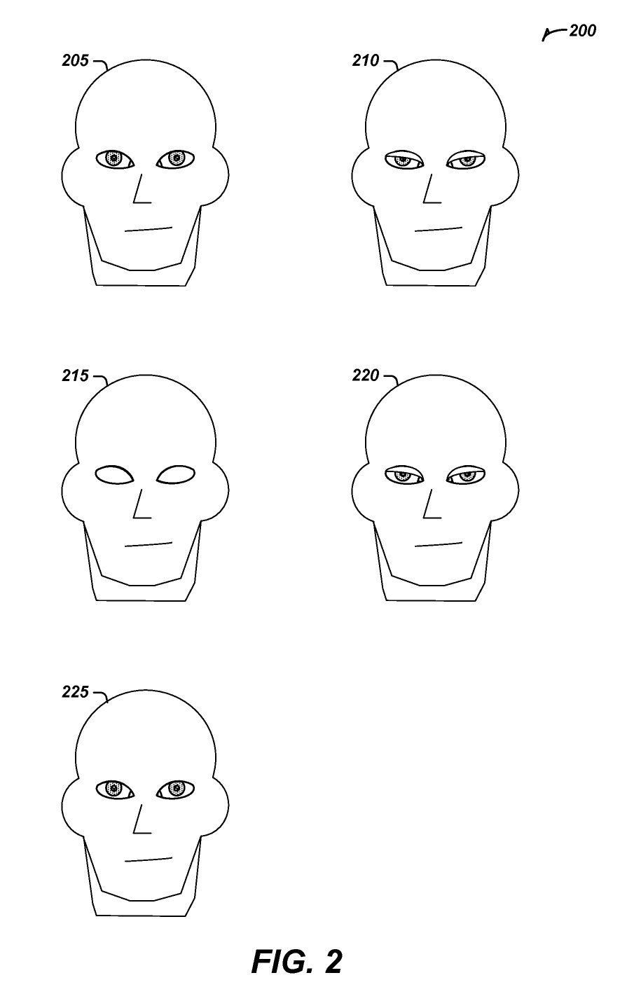

FIG. 2 is an example of a sequence 200 of eyelid movements in a blink, according to an embodiment. As the sequence 200 progresses from frame 205 to 210 to 215, the eyes are blinking shut. Frames 215 to 220 and 225 illustrate the opening portion of the blinking sequence 200.

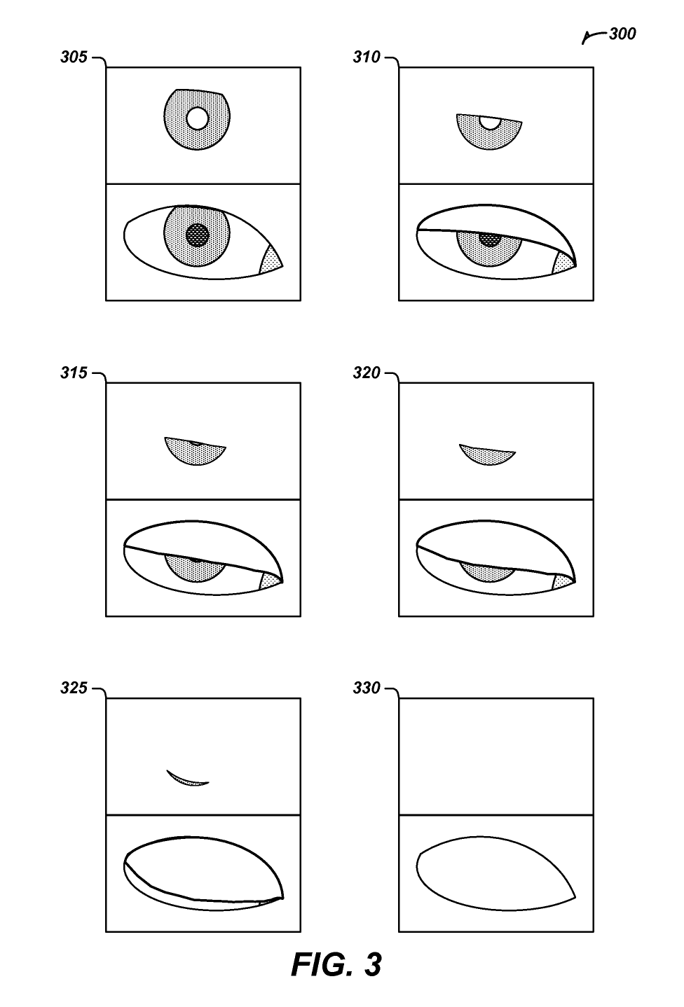

FIG. 3 is a sequence 300 of frames tracking blink characteristics of an eye, according to an embodiment. Specifically, the sequence 300 illustrates a typical human blink pattern as an eye transitions from an opened position to a closed position. Original images of the eyes (bottom), as well as binary (e.g., black and white) image versions of the eyes (top) are shown for each frame 305-330 to illustrate how an example tracks the eyelid's position in a sequence of frames. A sequence of eyelid positions, such as those illustrated, may be used to detect whether the eyelid in the sequence 300 of frames transitions between opened-eye (e.g., frame 305) and closed-eye (e.g., frame 330) positions in a natural (e.g., normal) or unnatural (e.g., abnormal) manner. In an example, pixel intensity changes are monitored from closed eye (e.g., frame 330), to partially opened eye (e.g., any of frames 310-325), and then to fully opened eye (e.g., frame 305). In an example, the pixel intensity changes are monitored in reverse order. In an example, the pixel intensity changes of both orders (e.g., closed eye to opened eye and opened eye to closed eye) are monitored. In an example, many (e.g., more than 3) different states of eyelid movement are monitored.

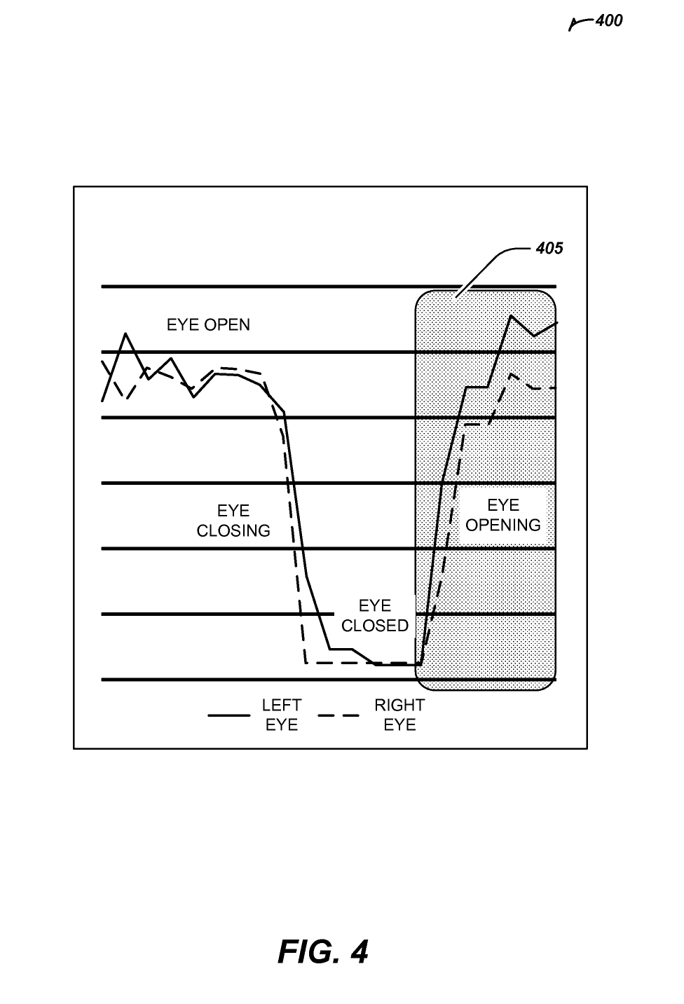

FIG. 4 is a chart 400 illustrating an eyelid sequence in a typical human blink pattern for each of two eyes, according to an embodiment. In chart 400, the x-axis is time and the y-axis is a measure of how open the eyelid is. As illustrated in FIG. 4, a normal blink pattern of a human follows a sinusoidal-like wave between the states of opened eye and closed eye. Furthermore, a normal blink pattern has a steady opened eye position prior to a blink, then substantially uniform closing and opening eyelid sequences during the blink.

Although the left eye and the right eye move in near synchronicity and produce similar movements, in a normal blink pattern of a human, the left and right eyes usually display slight variations between each other. Blinks simulated using manipulated images and image-manipulated animations usually do not show such sequences. In an example, a pattern recognizer operates on an eye opening movement 405, an eye closing movement, or both. In an example illustrated in chart 400, the pattern recognizer operates on the eye opening movement 405.

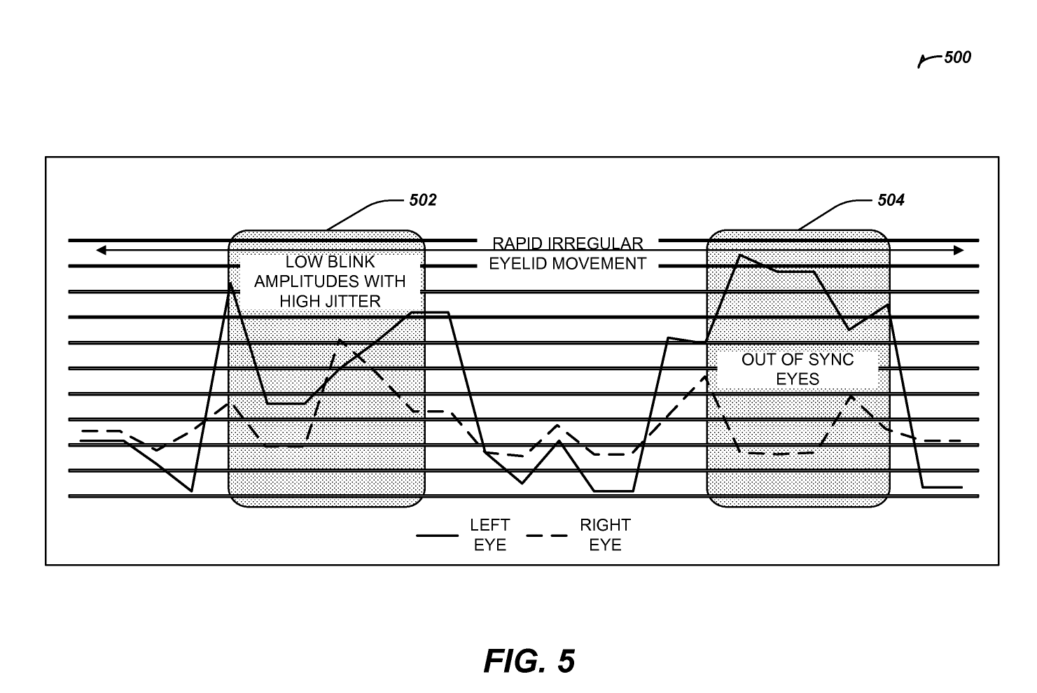

FIG. 5 illustrates an example abnormal blink pattern 500 for each of two eyes observed during a liveness spoofing attack based on an image-manipulated animation, according to an embodiment. In an example, eyelid movements that have low amplitudes and or high jitter are detected and flagged as abnormal. In an example, unsynchronized eyelid movements are detected and flagged as abnormal. In an example, unsynchronized eyelid movements include eyelids that move in opposite directions.

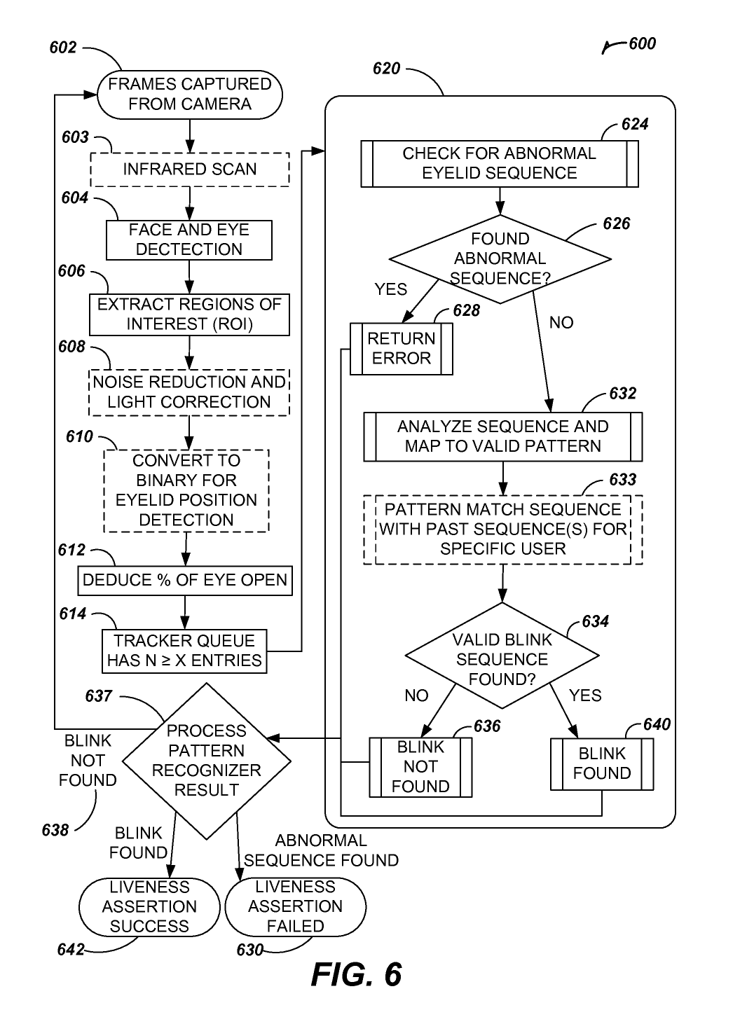

FIG. 6 is a flow diagram illustrating a method 600 for liveness detection in facial recognition with spoof-resistant progressive eyelid tracking, according to an embodiment.

At 602, a series of frames of a purportedly live human user are captured by a camera.

At 603, optionally, a portion of the camera's field of view (“FOV”) or angle of view (“AOV”) is scanned using an infrared (“IR”) sensor. In an example, the IR sensor detects thermal radiation emitted by matter within the FOV. In an example, the IR sensor detects thermal variations within and amongst the objects visible within the FOV of the IR sensor. Live, three-dimensional human faces have distinct variations in temperature (e.g., the tip of the nose is typically colder than the rest of the face, etc.), whereas two-dimensional images such as a photographs or screen displays do not exhibit these distinct variations in temperature. In an example, a thermal image captured by the IR sensor may be used to determine whether a face detected within the thermal image is live or not by comparing the thermal image of the face to a thermal model of a face, thereby determining whether the thermal image of the face exhibits these distinct variations in temperature.

In an example, the IR sensor detects an IR depth image (e.g., an image of the camera's FOV with depth coordinates associated with each pixel of the image.) Live, three-dimensional human faces have variations in depth (e.g., the nose protrudes farther than the lips, etc.), whereas two-dimensional images such as a photographs or screen displays do not have variations in depth. In an example, an IR depth image captured by the IR sensor may be used to determine whether a face detected within the IR depth image is live or not by comparing the IR depth image of the face to a depth model of a face, thereby determining whether the IR depth image of the face exhibits these variations in depth.

In an example, the IR depth image is generated by an IR light source (e.g., emitter) projecting structured (e.g., patterned) IR light onto a portion of the camera's FOV, then calculating the difference between the IR light structure emitted by the IR emitter and the IR light structure reflected by the objects in the FOV. In an example, the emitter of the IR light is the camera itself. In another example, the emitter of the IR light is an emitter separate from the camera. The pattern of IR light may be a dot pattern, a stripe pattern, etc.

In an example, the IR depth image is generated by an IR source emitting IR light onto a portion of the camera's FOV, then calculating the difference between the clock time when the IR light was emitted and the clock time when the IR sensor detected the IR light reflected by the objects in the FOV. This is also known as “flight time”.

At 604, a face and eye detection algorithm is executed on each captured frame. Images of faces that are further than 24 inches away from the camera lens tend to contain too much noise to be useful. In an example, only frames images containing face and eye regions with sufficient feature quality are processed for blink detection.

At 606, a region of interest (“ROI”) is extracted for each eye in each captured frame. Each respective ROI includes the respective eyelid for the respective eye.

At 608, optionally, image correction is performed on one or more ROIs of one or more frames to enhance eye features in poor quality images. In some optional examples, noise and/or gamma correction is performed on a ROI. In some optional examples, image artifacts caused by natural face movements (e.g., when walking or in a moving vehicle) are detected and eliminated (or otherwise factored out) using jitter-correction algorithms.

Some frames captured by the camera may have been captured under adverse lighting conditions (e.g., very dim light or very bright light) or when the user is wearing eyeglasses. In adverse lighting conditions, a lack of contrast between the eye and its surroundings may obscure the eye. When a user is wearing eyeglasses, a reflection off colored or even clear eyeglass lenses may obscure the eye. In these situations, an eye may be obscured in the visible light spectrum.

To address obscured or adverse lighting conditions, IR light may optionally be used to enhance the image to provide a better image of the region of interest. In an example, ambient IR light reflected off the objects in the camera's FOV is captured and used to produce an image of the region of interest. In an example, an IR emitter illuminates the objects in the camera's FOV (or a portion thereof) with IR light, and the reflected IR light reflected off the objects in the camera's FOV is captured and used to produce an image of the region of interest.

At 610, optionally, one or more ROIs of one or more frames are converted into binary (e.g., black and white) ROI images.

At 612, for each ROI image, the percentage of the eyelid that is open is determined, and a blink score corresponding to the percentage is produced. In an example, the blink score is then entered into an eyelid tracker queue.

At 614, a check is performed to ensure a sufficient quantity of blink score entries are in the eyelid tracker queue. In an example, a quantity N of blink score entries is deemed to be sufficient if N is greater than or equal to threshold quantity X. If a sufficient quantity of blink scores are in the eyelid tracker queue, the pattern recognizer 620 processes the series of blink scores in the eyelid tracker queue.

At 624, the pattern recognizer 620 checks the series of blink scores for an abnormal eyelid sequence that does not resemble natural human eye blink movements (e.g., rapid eyelid movement, erratic eyelid movement that does not trend in the same direction in consecutive entries, each eye not in sync with the other, etc.) For example, one or both eyes may have transitioned from an opened to closed state instantaneously rather than progressively. As another example, the right and left eyes may have moved in opposite directions.

In an example, the pattern recognizer 620 minimizes false detections of blinks resulting from jerky head movements by detecting and ignoring irregular eyelid movements, and only triggering a detection when a valid eyelid close-to-open (or open-to-close) cycle is detected. Such examples resist attacks using image-manipulated animations, as well as “waving photo” attacks that may trigger false detects in traditional blink algorithms.

At 626, a decision is made as to whether an abnormal sequence was found within the series of blink scores.

At 628, if an abnormal sequence was found within the series of blink scores, the pattern recognizer 620 will return an error and exit.

At 630, if the pattern recognizer 620 returned an error 628, a liveness failure will be asserted. In an example, the liveness failure includes an indication that a possible spoof attack was detected.

At 632, if the pattern recognizer 620 did not find an abnormal sequence within the series of blink scores, the pattern recognizer 620 will attempt to find within the series of blink scores a blink sequence that corresponds to a valid blink sequence pattern. A typical interval between human blinks is two to ten seconds, and a typical period for a blink is 100 ms to 400 ms. Thus, in an example, a blink sequence that contains blink cycles less than two seconds apart or greater than ten seconds apart will not correspond to a valid blink sequence pattern, and a blink sequence that contains blinks with periods of less than 100 ms or greater than 400 ms will not correspond to a valid blink sequence pattern.

At 633, optionally, the pattern recognizer 620 attempts to determine how closely correlated the series of blink scores is to one or more historical blink sequences of the user attempting authentication. In an example, if the correlation is above a determined threshold, the method 600 may be used as an authentication factor in addition to a liveness detection mechanism.

At 634, a decision is made as to whether a valid blink sequence was found within the series of blink scores.

At 636, if a valid blink sequence was not found within the series of blink scores, the pattern recognizer 620 exits, the pattern recognizer result is processed 637, and the method 600 for liveness detection restarts 638.

At 640, if a valid blink sequence was found within the series of blink scores, the pattern recognizer 620 exits, the pattern recognizer result is processed 637, and a liveness detection success 642 is asserted.

FIG. 7 is a block diagram illustrating an example of a machine 700, upon which one or more embodiments may be implemented. In an example, the machine 700 operates as a standalone device or is connected (e.g., networked) to other machines. In a networked deployment, the machine 700 operates in the capacity of a server machine, a client machine, or both in server-client network environments. In an example, the machine 700 acts as a peer machine in peer-to-peer (P2P) (or other distributed) network environment. In an example, the machine 700 is a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, although only a single machine 700 is illustrated, the term “machine” shall also be taken to include any collection of machines 700 that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations when operating. In an example, the hardware is specifically configured (e.g., hardwired) to perform a specific operation. In an example, the hardware includes configurable execution units (e.g., transistors, circuits, etc.) and a machine-readable medium 722 containing instructions 724, where the instructions 724 configure the execution units to perform a specific operation when in operation. In an example, the configuring occurs under the direction of the executions units or a loading mechanism. Accordingly, the execution units are communicatively coupled to the machine-readable medium 722 when the device is operating. In an example, the execution units are members of more than one module. In an example, under operation, the execution units are configured by a first set of instructions to implement a first module at one point in time and reconfigured by a second set of instructions to implement a second module at another point in time.

In an example, machine (e.g., computer system) 700 includes a hardware processor 702 (e.g., a central processing unit (CPU), a graphics processing unit (GPU), a hardware processor core, or any combination thereof), a main memory 704 and/or a static memory 706, some or all of which communicate with each other via an interlink (e.g., bus) 708. In an example, the machine 700 further includes a display unit 710, an alphanumeric input device 712 (e.g., a keyboard), and a user interface (UI) navigation device 714 (e.g., a mouse). In an example, the display unit 710, input device 712 and UI navigation device 714 are one or more touch screen displays. In an example, the machine 700 additionally includes a storage device (e.g., drive unit) 716, a signal generation device 718 (e.g., a speaker), a network interface device 720, and one or more sensors 721, such as a global positioning system (GPS) sensor, compass, accelerometer, or other sensor. In an example, the machine 700 includes an output controller 728, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.)

In an example, the storage device 716 includes a machine-readable medium 722, on which is stored one or more sets of data structures or instructions 724 (e.g., software) embodying or utilized by any one or more of the techniques or functions described herein. In an example, the instructions 724 also reside, completely or at least partially, within the main memory 704, within static memory 706, or within the hardware processor 702 during execution thereof by the machine 700. In an example, one or any combination of the hardware processor 702, the main memory 704, the static memory 706, or the storage device 716 constitute machine-readable media 722.

Although the machine-readable medium 722 is illustrated as a single medium, in an example, the term “machine-readable medium” include a single medium or multiple media (e.g., a centralized or distributed database, and/or associated caches and servers) configured to store the one or more instructions 724.

In an example, the term “machine-readable medium” includes any medium 722 that is capable of storing, encoding, or carrying instructions 724 for execution by the machine 700 and that cause the machine 700 to perform any one or more of the techniques of the present disclosure, or that is capable of storing, encoding, or carrying data structures used by or associated with such instructions 724. Non-limiting machine-readable medium 722 examples include solid-state memories, optical media, and magnetic media. In an example, a massed machine-readable medium 722 comprises a machine-readable medium 722 with a plurality of particles having resting mass. Specific examples of massed machine-readable media 722 include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

In an example, the instructions 724 are transmitted or received over a communications network 726 using a transmission medium via the network interface device 720 utilizing any one of a number of transfer protocols (e.g., frame relay, internet protocol (IP), transmission control protocol (TCP), user datagram protocol (UDP), hypertext transfer protocol (HTTP), etc.). Example communication networks include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMAX®), IEEE 802.15.4 family of standards, peer-to-peer (P2P) networks, among others. In an example, the network interface device 720 includes one or more physical jacks (e.g., Ethernet, coaxial, or phone jacks) or one or more antennas to connect to the communications network 726. In an example, the network interface device 720 includes a plurality of antennas to communicate wirelessly using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 700, and includes digital or analog communications signals or other intangible medium to facilitate communication of such software.

### Additional Notes & Examples

Example 1 includes subject matter (such as a device, apparatus, or machine) comprising: a camera to capture a series of frames in the visible light spectrum; a facial detector to detect, within each of a plurality of captured frames, a user's face including a pair of eyes; a region of interest extractor to extract, from each captured frame within the plurality of respective captured frames, a respective pair of regions of interest, each respective region of interest including a respective eye of the respective pair of eyes detected and a respective eyelid corresponding to the respective eye; an eye obstruction detector to calculate, for each region of interest, a respective score corresponding to a percentage of the respective eye unobstructed by the respective eyelid; and a liveness indicator to indicate liveness by a pattern recognizer to execute on a machine, the pattern recognizer to analyze the series of respective pairs of scores for an abnormal eyelid movement sequence.

In Example 2, the subject matter of Example 1 may include, wherein to indicate liveness includes, upon the pattern recognizer having found an abnormal eyelid sequence, the liveness indicator to assert the user's face detected within the captured series of frames was not alive during the capturing.

In Example 3, the subject matter of any one of Examples 1 to 2 may include, upon the pattern recognizer not having found an abnormal eyelid sequence, a second pattern recognizer to execute on a second machine, the second pattern recognizer to analyze the series of respective pairs of scores for a valid eyelid movement sequence.

In Example 4, the subject matter of any one of Examples 1 to 3 may include, wherein to indicate liveness includes, upon the second pattern recognizer having found a valid eyelid movement, the liveness indicator to assert the user's face detected within the captured series of frames was alive during the capturing.

In Example 5, the subject matter of any one of Examples 1 to 4 may include, wherein each respective pair of regions of interest includes: a respective left region of interest corresponding to a left eye and a left eyelid in the pair of eyes detected; a respective right region of interest corresponding to a right eye and a right eyelid in the pair of eyes detected; and wherein the abnormal eyelid sequence corresponds to the left eyelid and the right eyelid moving in opposite directions.

In Example 6, the subject matter of any one of Examples 1 to 5 may include, an infrared sensor to obtain an infrared image of the user's face; and wherein the liveness detection includes using the infrared image of the user's face.

In Example 7, the subject matter of any one of Examples 1 to 6 may include, wherein the series of frames are red-green-blue images, and wherein using the infrared image of the user's face includes combining a frame from the series of frames with the infrared image of the user's face.

In Example 8, the subject matter of any one of Examples 1 to 7 may include, an infrared emitter to illuminate a portion of the user's face; and an infrared reflection model of infrared light reflected off of a face.

In Example 9, the subject matter of any one of Examples 1 to 8 may include, wherein the infrared image is a thermal image.

In Example 10, the subject matter of any one of Examples 1 to 9 may include, wherein the infrared reflection model is an infrared depth image calculated from the reflected infrared light.

In Example 11, the subject matter of any one of Examples 1 to 10 may include a noise reduction module to reduce image noise within a captured frame from the series of frames.

In Example 12, the subject matter of any one of Examples 1 to 11 may include a light correction module to correct low levels of light within a captured frame from the series of frames.

In Example 13, the subject matter of any one of Examples 1 to 12 may include a conversion module to convert a region of interest to a binary image prior to calculating a respective score for the respective region of interest.

Example 14 includes subject matter (such as a method, means for performing acts, machine readable medium including instructions that when performed by a machine cause the machine to performs acts, or an apparatus to perform) comprising: capturing, from a camera, a series of frames in the visible light spectrum; detecting, within each of a plurality of captured frames, a user's face including a pair of eyes; extracting, from each captured frame within the plurality of respective captured frames, a respective pair of regions of interest, each respective region of interest including a respective eye of the respective pair of eyes detected and a respective eyelid corresponding to the respective eye; calculating, for each region of interest, a respective score corresponding to a percentage of the respective eye unobstructed by the respective eyelid; and indicating liveness by a pattern recognizer executing on a machine, the pattern recognizer analyzing the series of respective pairs of scores for an abnormal eyelid movement sequence.

In Example 15, the subject matter of Example 14 may include, wherein indicating liveness includes, upon the pattern recognizer finding an abnormal eyelid sequence, asserting the user's face detected within the captured series of frames was not alive during the capturing.

In Example 16, the subject matter of any one of Examples 14 to 15 may include, upon the pattern recognizer not finding an abnormal eyelid sequence, a second pattern recognizer executing on a second machine the second pattern recognizer analyzing the series of respective pairs of scores for a valid eyelid movement sequence.

In Example 17, the subject matter of any one of Examples 14 to 16 may include, wherein indicating liveness includes, upon the second pattern recognizer finding a valid eyelid movement, asserting the user's face detected within the captured series of frames was alive during the capturing.

In Example 18, the subject matter of any one of Examples 14 to 17 may include, wherein each respective pair of regions of interest includes: a respective left region of interest corresponding to a left eye and a left eyelid in the pair of eyes detected; a respective right region of interest corresponding to a right eye and a right eyelid in the pair of eyes detected; and wherein the abnormal eyelid sequence corresponds to the left eyelid and the right eyelid moving in opposite directions.

In Example 19, the subject matter of any one of Examples 14 to 18 may include, obtaining an infrared image of the user's face via an infrared sensor; and wherein the liveness detection includes using the infrared image of the user's face.

In Example 20, the subject matter of any one of Examples 14 to 19 may include, wherein the series of frames are red-green-blue images, and wherein using the infrared image of the user's face includes combining a frame from the series of frames with the infrared image of the user's face.

In Example 21, the subject matter of any one of Examples 14 to 20 may include, illuminating a portion of the user's face with infrared light; and using an infrared reflection model of infrared light reflected off of a face.

In Example 22, the subject matter of any one of Examples 14 to 21 may include, wherein the infrared image is a thermal image.

In Example 23, the subject matter of any one of Examples 14 to 22 may include, wherein the infrared reflection model is an infrared depth image calculated from the reflected infrared light.

In Example 24, the subject matter of any one of Examples 14 to 23 may include, reducing image noise within a captured frame from the series of frames.

In Example 25, the subject matter of any one of Examples 14 to 24 may include, correcting low levels of light within a captured frame from the series of frames.

In Example 26, the subject matter of any one of Examples 14 to 25 may include, converting a region of interest to a binary image prior to calculating a respective score for the respective region of interest.

Example 27 includes an apparatus comprising means to perform a method as in any of the preceding Examples.

Example 28 includes a machine-readable storage medium including instructions, which when executed by a machine, cause the machine to implement a method or realize an apparatus of any of the preceding Examples.

Conventional terms in the fields of facial recognition, pattern recognition, and computer security have been used herein. The terms are known in the art and are provided only as a non-limiting example for convenience purposes. Accordingly, the interpretation of the corresponding terms in the claims, unless stated otherwise, is not limited to any particular definition.

Although specific embodiments have been illustrated and described herein, it will be appreciated by those of ordinary skill in the art that any arrangement that is calculated to achieve the same purpose may be substituted for the specific embodiments shown. Many adaptations will be apparent to those of ordinary skill in the art. Accordingly, this application is intended to cover any adaptations or variations.

The above Detailed Description includes references to the accompanying drawings, which form a part of the detailed description. The drawings show, by way of illustration, specific embodiments, in which methods, apparatuses, and systems discussed herein, may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

The flowcharts and block diagrams in the FIGS. illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block could occur out of the order noted in the figures. For example, two blocks shown in succession may be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts, or combinations of special purpose hardware and computer instructions.

The functions or process described herein may be implemented in software or a combination of software and human implemented procedures. The software may consist of machine-executable instructions stored on machine-readable media, such as memory or other type of storage devices. The term “machine-readable media” is also used to represent any means, by which the machine-readable instructions may be received by the machine, such as by different forms of wired or wireless transmissions. Further, such functions correspond to modules, which are software, hardware, firmware, or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system. In this document, the terms “a” or “an” are used, as is common in patent documents, to include one or more than one, independent of any other instances or usages of “at least one” or “one or more.”

In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

As used herein, a “-” (dash) used when referring to a reference number means “or”, in the non-exclusive sense discussed in the previous paragraph, of all elements within the range indicated by the dash. For example, 103A-B means a nonexclusive “or” of the elements in the range {103A, 103B}, such that 103A-103B includes “103A but not 103B,” “103B but not 103A,” and “103A and 103B”.

The above description is intended to be illustrative, and not restrictive. For example, the above-described examples (or one or more aspects thereof) may be used in combination with each other. Other embodiments may be used, such as by one of ordinary skill in the art upon reviewing the above description. Furthermore, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments may be combined with each other in various combinations or permutations. The scope of the embodiments should be determined with reference to the appended claims, along with the full scope of equivalents to which such claims are entitled.

What is claimed is:

1. A system for liveness detection using progressive eyelid tracking, the system comprising:
a camera to capture a series of frames in the visible light spectrum;
a facial detector to detect, within each of a plurality of captured frames, a user's face including a pair of eyes;
a region of interest extractor to extract, from each captured frame within the plurality of respective captured frames, a respective pair of regions of interest, each respective region of interest including a respective eye of the respective pair of eyes detected and a respective eyelid corresponding to the respective eye;
an eye obstruction detector to calculate, for each region of interest, a respective score corresponding to a percentage of the respective eye unobstructed by the respective eyelid; and
a liveness indicator to indicate liveness by a pattern recognizer to execute on a machine, the pattern recognizer to analyze the series of respective pairs of scores for an abnormal eyelid movement sequence.

2. The system of claim 1, wherein to indicate liveness includes, upon the pattern recognizer having found an abnormal eyelid sequence, the liveness indicator to assert the user's face detected within the captured series of frames was not alive during the capturing.

3. The system of claim 1, further comprising:
upon the pattern recognizer not having found an abnormal eyelid sequence, a second pattern recognizer to execute on a second machine, the second pattern recognizer to analyze the series of respective pairs of scores for a valid eyelid movement sequence.

4. The system of claim 3, wherein to indicate liveness includes, upon the second pattern recognizer having found a valid eyelid movement, the liveness indicator to assert the user's face detected within the captured series of frames was alive during the capturing.

5. The system of claim 1, wherein each respective pair of regions of interest includes:
a respective left region of interest corresponding to a left eye and a left eyelid in the pair of eyes detected;
a respective right region of interest corresponding to a right eye and a right eyelid in the pair of eyes detected; and
wherein the abnormal eyelid sequence corresponds to the left eyelid and the right eyelid moving in opposite directions.

6. The system of claim 1, further comprising:
an infrared sensor to obtain an infrared image of the user's face; and
wherein the liveness detection includes using the infrared image of the user's face.

7. The system of claim 6, wherein the series of frames are red-green-blue images, and wherein using the infrared image of the user's face includes combining a frame from the series of frames with the infrared image of the user's face.

8. The system of claim 6, further comprising:
an infrared emitter to illuminate a portion of the user's face; and
an infrared reflection model of infrared light reflected off of a face.

9. The system of claim 8, wherein the infrared image is a thermal image.

10. The system of claim 8, wherein the infrared reflection model is an infrared depth image calculated from the reflected infrared light.

11. A method for liveness detection with progressive eyelid tracking, the method comprising:
capturing, from a camera, a series of frames in the visible light spectrum;
detecting, within each of a plurality of captured frames, a user's face including a pair of eyes;
extracting, from each captured frame within the plurality of respective captured frames, a respective pair of regions of interest, each respective region of interest including a respective eye of the respective pair of eyes detected and a respective eyelid corresponding to the respective eye;
calculating, for each region of interest, a respective score corresponding to a percentage of the respective eye unobstructed by the respective eyelid; and
indicating liveness by a pattern recognizer executing on a machine, the pattern recognizer analyzing the series of respective pairs of scores for an abnormal eyelid movement sequence.

12. The method of claim 11, wherein indicating liveness includes, upon the pattern recognizer finding an abnormal eyelid sequence, asserting the user's face detected within the captured series of frames was not alive during the capturing.

13. The method of claim 11, further comprising:
upon the pattern recognizer not finding an abnormal eyelid sequence, a second pattern recognizer executing on a second machine the second pattern recognizer analyzing the series of respective pairs of scores for a valid eyelid movement sequence.

14. The method of claim 13, wherein indicating liveness includes, upon the second pattern recognizer finding a valid eyelid movement, asserting the user's face detected within the captured series of frames was alive during the capturing.

15. The method of claim 11, wherein each respective pair of regions of interest includes:
a respective left region of interest corresponding to a left eye and a left eyelid in the pair of eyes detected;
a respective right region of interest corresponding to a right eye and a right eyelid in the pair of eyes detected; and
wherein the abnormal eyelid sequence corresponds to the left eyelid and the right eyelid moving in opposite directions.

16. The method of claim 11, further comprising:
obtaining an infrared image of the user's face via an infrared sensor; and
wherein the liveness detection includes using the infrared image of the user's face.

17. The method of claim 16, wherein the series of frames are red-green-blue images, and wherein using the infrared image of the user's face includes combining a frame from the series of frames with the infrared image of the user's face.

18. The method of claim 16, further comprising:
illuminating a portion of the user's face with infrared light; and
using an infrared reflection model of infrared light reflected off of a face.

19. The method of claim 18, wherein the infrared image is a thermal image.

20. The method of claim 18, wherein the infrared reflection model is an infrared depth image calculated from the reflected infrared light.

21. A machine-readable storage medium including instructions which, when executed by a machine, cause the machine to perform operations comprising:
capturing, from a camera, a series of frames in the visible light spectrum;
detecting, within each of a plurality of captured frames, a user's face including a pair of eyes;
extracting, from each captured frame within the plurality of respective captured frames, a respective pair of regions of interest, each respective region of interest including a respective eye of the respective pair of eyes detected and a respective eyelid corresponding to the respective eye;
calculating, for each region of interest, a respective score corresponding to a percentage of the respective eye unobstructed by the respective eyelid; and
indicating liveness by a pattern recognizer executing on a machine, the pattern recognizer analyzing the series of respective pairs of scores for an abnormal eyelid movement sequence.

22. The machine-readable storage medium of claim 21, wherein indicating liveness includes, upon the pattern recognizer finding an abnormal eyelid sequence, asserting the user's face detected within the captured series of frames was not alive during the capturing.

23. The machine-readable storage medium of claim 21, further comprising:
upon the pattern recognizer not finding an abnormal eyelid sequence, a second pattern recognizer executing on a second machine the second pattern recognizer analyzing the series of respective pairs of scores for a valid eyelid movement sequence.

24. The machine-readable storage medium of claim 23, wherein indicating liveness includes, upon the second pattern recognizer finding a valid eyelid movement, asserting the user's face detected within the captured series of frames was alive during the capturing.

25. The machine-readable storage medium of claim 21, wherein each respective pair of regions of interest includes:
a respective left region of interest corresponding to a left eye and a left eyelid in the pair of eyes detected;
a respective right region of interest corresponding to a right eye and a right eyelid in the pair of eyes detected; and
wherein the abnormal eyelid sequence corresponds to the left eyelid and the right eyelid moving in opposite directions.
